(19) United States
(12) Patent Application Publication
(10) Pub. No.: US 2005/0259181 A1
(43) Pub. Date: Nov. 24, 2005

(54) Video signal receiving apparatus and method

(75) Inventor: Kiyomi Watanabe, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/132,421

(22) Filed: May 19, 2005

(30) Foreign Application Priority Data
May 20, 2004 (JP) 2004-150642

(51) Int. Cl. H04N 5/268

(52) U.S. Cl. 348/554; 348/706

(57) ABSTRACT

A video signal receiving apparatus comprises a HDMI receiver, signal processing section and control section. The HDMI receiver separates a digital signal conformable to HDMI standards into video component and audio component, determining whether a received digital video signal is a RGB or YCbCr signal, and changing its setting in accordance with the determination result. The signal processing section decodes video signal and audio signal separated by the HDMI receiver to restore analog video signal and audio signal. The control section changes the setting of the HDMI receiver by an operation.

### CROSS-REFERENCE TO RELATED APPLICATIONS

This application is based upon and claims the benefit of priority from prior Japanese Patent Application No. 2004-150642, filed May 20, 2004, the entire contents of which are incorporated herein by reference.

### BACKGROUND OF THE INVENTION

1. Field of the Invention

The present invention relates to a standardized digital transmission system, which transmits a digital video signal having a digital audio signal multiplexed for a predetermined period. In particular, the present invention relates to video signal receiving apparatus and method for receiving a transmitted digital video signal.

2. Description of the Related Art

As is well known, the DVI (Digital Visual Interface) standards have come to wide use as the standards for transmitting a digital video signal. Recently, the HDMI (High Definition Multimedia Interface) standards have been employed as the standards of further improving the DVI standards.

The HDMI standards includes the following various regulations, which have not been provided in the DVI standards. According to the HDMI standards, a digital audio signal is multiplexed for a blanking period of a digital video signal to make sound transmission. The digital video signal is transmitted in an RGB signal mode, YCbCr signal mode or YPbPr signal mode having image quality higher than the YCbCr signal. A connection is made using a USB (Universal Serial Bus)—like small-sized HDMI connector.

Thus, in order to build up a digital transmission system conformable to the HDMI standards, there is a need of taking various considerations, which have not been given in the transmission system conformable to the VDI standards. For example, according to the HDMI standards, the video signal is transmittable in two kinds of modes, i.e., digital RGB signal mode and digital YCbCr or YPbPr signal mode. For this reason, a receiver has a need to make signal processing in accordance with a received video signal mode to correctly make video display.

JPN. PAT. APPLN. KOKAI Publication No. 2002-314970 discloses the configuration of controlling a source device from a sink device in a system conformable to the DVI standards. However, the foregoing Publication has no disclosure relevant to the following technique. Namely, the receiver makes proper processing with respect to two kinds of digital video signal modes in a digital transmission system conformable to the HDMI standards.

### BRIEF SUMMARY OF THE INVENTION

According to one aspect of the present invention, there is provided a video signal receiving apparatus comprising:

a receiving section configured to receive a digital video signal conformable to HDMI standards;

a HDMI receiver separating the digital video signal received by the receiving section into video component and audio component, determining whether the received digital video signal is a RGB or YCbCr signal, and changing its setting in accordance with the determination result;

a signal processing section configured to restore video signal and audio signal separated by the HDMI receiver to analog video signal and audio signal; and

a control section configured to change the setting of the HDMI receiver by an operation.

According to another aspect of the present invention, there is provided a video signal receiving method comprising:

a first step of receiving a digital signal conformable to HDMI standards;

a second step of determining whether a received digital video signal is a RGB or YCbCr signal, and changing its setting in accordance with the determination result in a HDMI receiver separating the received digital signal into video component and audio component,

a third step of restoring video signal and audio signal separated by the HDMI receiver to analog video signal and audio signal; and

a fourth step of changing the setting of the HDMI receiver by an operation.

### BRIEF DESCRIPTION OF THE SEVERAL VIEWS OF THE DRAWING

FIG. 1 is a block diagram to explain the configuration of a video signal receiving apparatus according to one embodiment of the present invention;

FIG. 2 is a flowchart to explain the operation of the signal receiving apparatus according to the embodiment; and

FIG. 3 is a flowchart to explain the operation of changing the setting of a HDMI receiver of the signal receiving apparatus according to the embodiment.

### DETAILED DESCRIPTION OF THE INVENTION

One embodiment of the present invention will be described below with reference to the accompanying drawings.

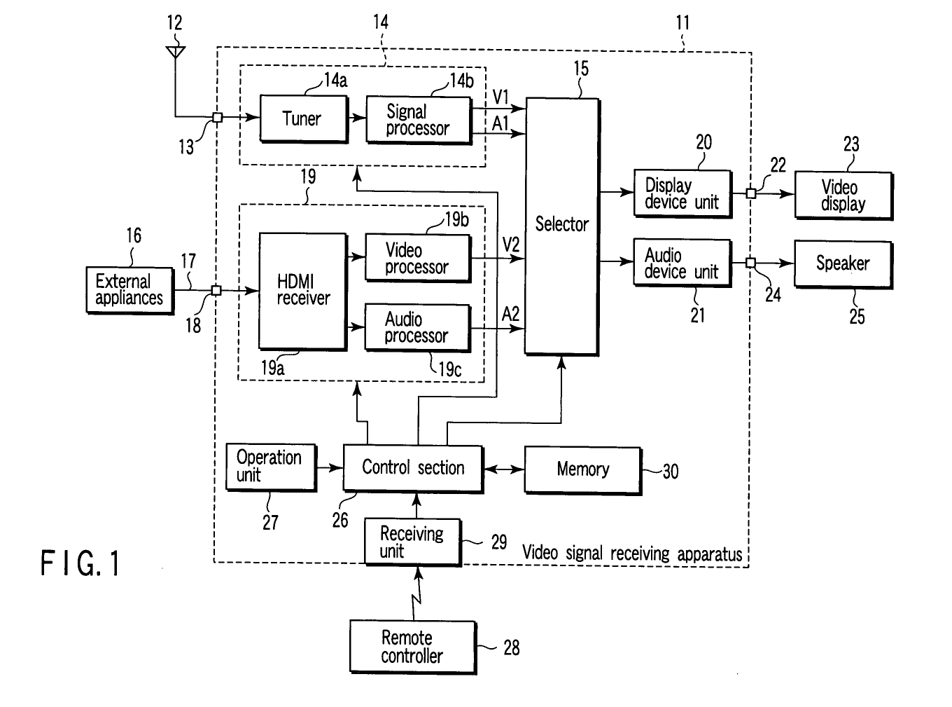

FIG. 1 shows a video signal receiving apparatus 11 explained in this embodiment. The video signal receiving apparatus 11 has the functions given below. One is a function of receiving a television broadcast signal, and another is a function of receiving a digital video signal conformable to the HDMI standards.

More specifically, a television broadcast signal is received by an antenna 12, and then, supplied to a television signal processing section 14 via a TV (television) input terminal 13. The television signal processing section 14 has tuner 14a and signal processor 14b.

The television broadcast signal inputted to the TV input terminal 13 is supplied to the tuner 14a so that a predetermined channel signal is extracted. Thereafter, an output signal of the tuner 14a is supplied to the signal processor 14b, and then, restored to analog video signal V1 and audio signal A1, and outputted to a sector 15.

Moreover, a digital video signal is supplied from an external appliance 16 via a digital transmission bus 17 conformable to the HDMI standards. The digital video signal is received by a HDMI input terminal 18, and then, supplied to a HDMI signal processing section 19. The HDMI signal processing section 19 has HDMI receiver 19a, video processor 19b and audio processor 19c.

An HDMI-standard digital video signal received by the HDMI input terminal 18 is supplied to the HDMI receiver 19a. The HDMI receiver 19a separates the inputted digital video signal into video component and audio component. In this case, HDMI receiver 19a outputs the video component after subjecting it to MPEG (Moving Picture Experts Group) decoding. Thereafter, the video component is supplied to the video processor 19b, and then, restored to an analog video signal V2.

The audio component separated by the HDMI receiver 19a is supplied to the audio processor 19c, and then, subject to linear PCM (Pulse Code Modulation) decoding, and thereafter, restored to an analog audio signal A2. The foregoing analog video and audio signals V2 and A2 outputted from the video and audio processors 19b and 19c are supplied to the selector 15.

The HDMI receiver 19a may have the following configuration. More specifically, the HDMI receiver 19a separates the inputted digital video signal into video component and audio component. Thereafter, the video processor 19b decodes the video component to restore the analog video signal; on the other hand, the audio processor 19c decodes the audio component to restore the analog audio signal.

Moreover, the HDMI receiver 19a may have the following configuration. More specifically, the HDMI receiver 19a separates the inputted digital video signal into video component and audio component, and thereafter, decodes the foregoing video and audio components. Then, the video processor 19b restores the analog video signal; on the other hand, the audio processor 19c restores the analog audio signal.

Moreover, the HDMI receiver 19a may have the following configuration. More specifically, the HDMI receiver 19a separates the inputted digital video signal into video component and audio component, and decodes the audio component. Then, the video processor 19b decodes the video to restore the analog video signal; on the other hand, the audio processor 19c restores the analog audio signal.

The selector 15 has a function described below. The selector 15 selectively switches analog video signal V1 and audio signal A1 outputted from the television signal processing section 14 and analog video signal V2 and audio signal A2 outputted from the HDMI signal processing section 19. Thereafter, the selector 15 supplies the signal thus switched to display drive unit 20 and audio drive unit 21.

The video signal V1 or V2 supplied to the display drive unit 20 is subjected to signal processing necessary for video display. Thereafter, the video signal V1 or V2 is supplied to a video display 23 via a video output terminal 22, and thus, a video image is displayed. The audio signal A1 or A2 supplied to the audio drive unit 21 is subjected to signal processing necessary for audio reproduction. Thereafter, the audio signal A1 or A2 is supplied to a speaker 25 via an audio output terminal 24, and thus, audio is reproduced.

In the video signal receiving apparatus 11, a control section 26 collectively controls the entire operations including the foregoing various receiving operations. The control section 26 has a built-in CPU (Central Processing Unit), and receives operational information from an operation unit 27 or receives operational information sent from a remote controller 28 via a receiving unit 29. The control section 26 controls the foregoing sections and units so that the operational contents are reflected.

In this case, the control section makes use of a memory 30. More specifically, the memory 30 mainly includes read-only memory, read/write memory and non-volatile memory. The read-only memory stores control programs executed by the CPU of the control section 26. The read/write memory provides a work area with respect to the CPU. The non-volatile memory stores various setting information and control information.

According to the HDMI standards, the digital video signal is transmitted in a state of being divided into a unit of predetermined packet. Each packet is appended with information data showing attribute. The information data includes identification showing whether the transmitting video signal is a digital RGB signal or digital YCbCr (or YPbPr) signal.

The foregoing digital YCbCr and YPbPr signals are merely different in its image quality, and has the same mode signal distinguished from the digital RGB signal. Thus, if the digital YCbCr signal is described in the following explanation, it may be replaceable with the digital YPbPr signal.

The HDMI receiver 19a forming the HDMI signal processing section 19 automatically determines whether the video signal is digital RGB signal or digital YCbCr signal based on the identification included in the information data. The HDMI receiver 19a changes internal setting to make signal processing corresponding to the determination result, and thus, video display is correctly made.

In this case, the internal setting of HDMI receiver 19a is changed in the following manner in order to make signal processing corresponding to digital RGB signal or digital YCbCr signal. Namely, user operates the operation unit 27 or predetermined keys of the remote control 28, and thereby, the internal setting is changed on manual.

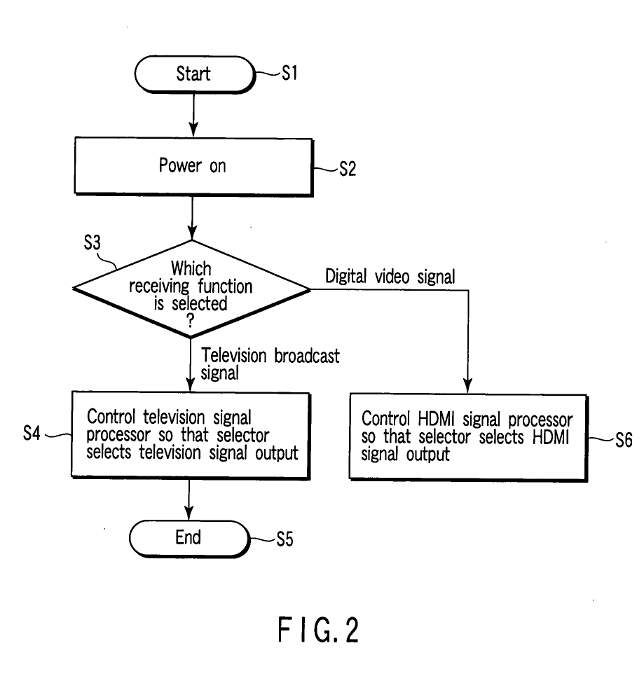

FIG. 2 is a flowchart to explain the operation of the video signal receiving apparatus 11. The operation is started (step S1), and when power-on is turned in step S2, the control section 26 determines which of the foregoing two receiving functions is selected in step S3.

In this case, if receiving the television broadcast signal is selected; the control section 26 controls the television signal processing section 14 in step S4. The control section 26 controls the selector 15 to select the analog video signal V1 and audio signal A1 outputted from the television signal processing section 14, and then, ends the procedure (step S5).

On the other hand, if receiving the digital video signal conformable to the HDMI standards is selected in step S3, the control section 26 controls the HDMI signal processing section 19 in step S6. The control section 26 controls the selector 15 to select the analog video signal V1 and audio signal A1 outputted from the HDMI signal processing section 19, and then, ends the procedure (step S5).

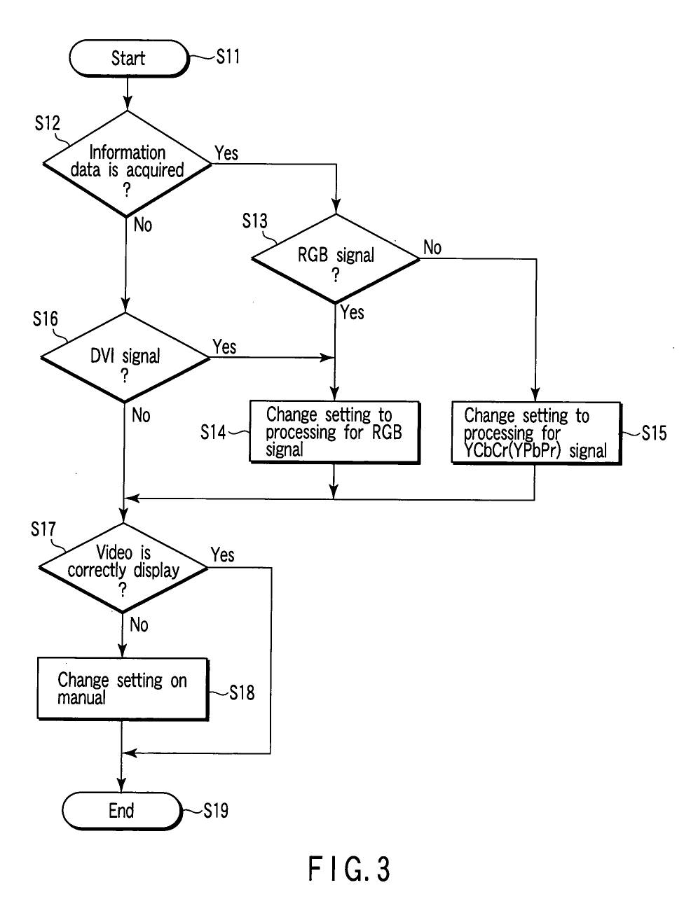

FIG. 3 is a flowchart to explain the operation of changing the setting of the HDMI receiver 19a when receiving the digital video signal conformable to the HDMI standards is selected. In this case, the setting is changed in accordance with the determination whether the received video signal is a digital RGB or YCbCr signal.

When the operation is start (step S11), the HDMI receiver 19a determines in step S12 whether or not information data is correctly obtained from the received signal. If it is determined that the information data is correctly obtained (YES), the HDMI receiver 19a takes the following procedure. Namely, the HDMI receiver 19a determines in step S13 whether the received video signal is a digital RGB signal based on identification included in the information data.

If it is determined that the received video signal is the digital RGB signal (YES), the HDMI receiver 19a changes the internal setting to make signal processing corresponding to the digital RGB signal in step S14.

On the other hand, if it is determined in step S13 that the received video signal is not the digital RGB signal (NO), the HDMI receiver 19a determines that the received video signal is a digital YCbCr signal. In step S15, the HDMI receiver 19a changes the internal setting to make signal processing corresponding to the digital YCbCr signal.

Resulting from the reason why the receiving state is worsened and information data is lack, the information data is not correctly obtained or it is determined that there exists no information data (NO) in step S12. In this case, the HDMI receiver 19a determines in step S16 whether or not the received signal is a digital video signal conformable to the DVI standards.

If it is determined that the received signal is a digital video signal conformable to the DVI standards (YES), the HDMI receiver 19a takes the following procedure in step S14. Namely, the HDMI receiver 19a changes the internal setting to make signal processing corresponding to the digital RGB signal because the video signal according to the DVI standards has digital RGB signal mode only.

If it is determined in step S16 that the received signal is not a digital video signal conformable to the DVI standards (NO), the HDMI receiver 19a can not automatically determine whether the received video signal is a digital RGB or YCbCr signal.

The following procedure is taken if it is determined in step S16 that the received signal is not a digital video signal conformable to the DVI standards (NO). In step S17 after the steps S14 and S15, user watches the displayed video image to determine whether or not the video image is correctly displayed.

If the user determines that the video image is correctly displayed (YES), the setting of the HDMI receiver 19a is unchanged, and the procedure ends (step S19).

If the user determines that the video image is not correctly displayed (NO), the user operates the operation section 27 or predetermined keys of the remote controller 28 in step S18. By doing so, the internal setting of the HDMI receiver 19a is changed on manual, and the procedure ends (step S19).

In this case, the change of the internal setting of the HDMI receiver 19a on manual is made preferentially to the foregoing step S14 or S15. For example, an erroneous determination is given in steps S12, S13 and S16, the user watches the displayed video image, and thereafter, finally selects correct setting; therefore, correct video image is displayed.

According to the foregoing embodiment, so long as information data is correctly obtained from the received signal, the internal setting of the HDMI receiver 19a is automatically changed based on identification included in the information data. If the information data is correctly obtained, user can change the internal setting of the HDMI receiver 19a on manual. Therefore, signal processing corresponding to the received video signal mode is always achieved, and therefore, a video image is correctly displayed.

The following appliances including video display 23 and speaker 24 are given as the video signal receiving apparatus 11 of the foregoing embodiment. For example, television broadcast receivers using a CRT (Cathode Ray Tube) and liquid crystal display screen, and projection type video display device are given.

The following appliances are given as the external devices supplying a digital video signal conformable to the HDMI standards to the video signal receiving apparatus 11. For example, DVD (Digital Versatile Disk) player, D (Digital)-VHS (Video Home System) recorder, set-top box and digital video camera are given.

The present invention is not limited to the foregoing embodiment, and in the working stage of the invention, components are modified and embodied within the scope without departing from the subject matter of the invention. Several components disclosed in the foregoing embodiment are properly combined, and thereby, various inventions are formed. For example, some components may be deleted from all components disclosed in the embodiment. Moreover, components relevant to the embodiment may be properly combined.

1. A video signal receiving apparatus comprising:
a receiving section configured to receive a digital signal conformable to HDMI standards;
a HDMI receiver configured to separate the digital signal received by the receiving section into video component and audio component, to determine whether a received digital video signal is a RGB or YCbCr signal, and to change its setting in accordance with the determination result;
a signal processing section configured to restore video signal and audio signal separated by the HDMI receiver to analog video signal and audio signal; and
a control section configured to change the setting of the HDMI receiver by an operation.

2. The apparatus according to claim 1, wherein the HDMI receiver determines whether a received digital video signal is a digital RGB or YCbCr signal based on identification of information data included in the digital signal received by the receiving section.

3. The apparatus according to claim 1, wherein the HDMI receiver automatically changes its internal setting to make signal processing corresponding to the digital RGB signal when it is determined that the received digital video signal is the digital RGB signal, and automatically changes its internal setting to make signal processing corresponding to the digital YCbCr signal when it is determined that the received digital video signal is the digital YCbCr signal.

4. The apparatus according to claim 1, wherein a change of the setting of the HDMI receiver by the control section is made preferentially to an automatically change setting by the HDMI receiver.

5. A video signal receiving apparatus comprising:
a receiving section configured to receive a digital signal in which a digital audio signal is multiplexed for a predetermined period;
a separation section configured to separate the digital signal received by the receiving section into video component and audio component, to determine whether a received digital video signal is a RGB or YCbCr signal, and to change setting in accordance with the determination result;
a signal processing section configured to restore video signal and audio signal separated by the separation section to analog video signal and audio signal; and
a control section configured to change the setting of the separation section by an operation.

6. The apparatus according to claim 5, further comprising:
a broadcast receiving section configured to receive a television broadcast signal;
a broadcast signal processing section configured to select (tune) a predetermined channel signal from the television broadcast signal received by the broadcast receiving section, and to restore analog video signal and audio signal; and
a selector section configured to selectively switch and output the analog video signal and audio signal restored by the broadcast signal processing section and the analog video signal and audio signal restored by the signal processing section.

7. A video signal receiving method comprising:
a first step of receiving a digital signal conformable to HDMI standards;
a second step of determining whether a received digital video signal is a RGB or YCbCr signal, and changing its setting in accordance with the determination result in a HDMI receiver separating the received digital signal into video component and audio component,
a third step of restoring video signal and audio signal separated by the HDMI receiver to analog video signal and audio signal; and
a fourth step of changing the setting of the HDMI receiver by an operation.

8. The method according to claim 7, wherein the second step includes determining whether a received digital video signal is a digital RGB or YCbCr signal based on identification of information data included in the digital signal received by the receiving section.

9. The method according to claim 7, wherein the second step includes:
automatically changing internal setting of the HDMI receiver to make signal processing corresponding to the digital RGB signal when it is determined that the received digital video signal is the digital RGB signal, and
automatically changing the internal setting of the HDMI receiver to make signal processing corresponding to the digital YCbCr signal when it is determined that the received digital video signal is the digital YCbCr signal.

10. The method according to claim 7, wherein a change of the setting of the HDMI receiver in the fourth step is made preferentially to the setting changed in the second step.
